(19) United States
(12) Patent Application Publication
(10) Pub. No.: US 2025/0368276 A1
(43) Pub. Date: Dec. 4, 2025

(54) VEHICLE STRUCTURAL MEMBER

(71) Applicant: FORD GLOBAL TECHNOLOGIES, LLC, Dearborn, MI (US)

(72) Inventors: Scott J. BELL, Northville, MI (US); Mikolaj TYKSINSKI, Madison, WI (US); Mangesh KADAM, Canton, MI (US); Ryan CRAIG, Novi, MI (US); Leonard Anthony SHANER, New Baltimore, MI (US); Sankarsh Kanth AEKBOTE, Farmington, MI (US); Marius CUREA, Canton, MI (US); Jeffrey A. WALESCH, Canton, MI (US); Benjamin MANSFIELD, Battle Creek, MI (US); Tushar B. KAMBLE, Canton, MI (US); Krishnakanth E. AEKBOTE, Novi, MI (US)

(21) Appl. No.: 18/680,387

(22) Filed: May 31, 2024

(51) Int. Cl. B62D 27/02; B62D 21/02; B62D 21/15

(52) U.S. Cl. CPC B62D 27/023; B62D 21/02; B62D 21/152

(57) ABSTRACT

A vehicle includes a frame having a longitudinal rail and a structural member supported by the frame. The structural member includes a front bracket joined to the rail and having an arm that extends outwardly away from the rail. The structural member further includes a curved elongate member having a first end connected to an outer end of the arm and extending rearwardly therefrom to a second end that is spaced from the rail. A rear bracket of the structural member is connected to the rail and defines a slot that receives the second end of the curved elongate member therein. A width of the slot is wider than a width of the second end such that the second end can slide rearwardly within the slot.

### TECHNICAL FIELD

This disclosure relates to vehicle structural members joined to a frame or body structure.

### BACKGROUND

Most vehicles have unibody or body-on-frame construction. In unibody construction, the body and frame are integrally formed, whereas in body-on-frame construction, a separate body is bolted to the frame. In both constructions, the frame supports the weight of the vehicle and loads and includes attachments for connecting with the vehicle suspension.

### SUMMARY

According to one embodiment, a vehicle includes a frame having a longitudinal rail and a structural member supported by the frame. The structural member includes a front bracket joined to the rail and having an arm that extends outwardly away from the rail. The structural member further includes a curved elongate member having a first end connected to an outer end of the arm and extending rearwardly therefrom to a second end that is spaced from the rail. A rear bracket of the structural member is connected to the rail and defines a slot that receives the second end of the curved elongate member therein. A width of the slot is wider than a width of the second end such that the second end can slide rearwardly within the slot. The vehicle may further include a front wheel assembly, and the structural member may be disposed forward of the front wheel assembly.

The front bracket may define an opening. The front bracket may be received on the rail via the opening. For example, the opening may be located on a bottom of the bracket allowing the bracket to be placed on the rail from the top.

The second end of the curved elongate member may be connected to the rear bracket by a shear member that connects the second end at a front portion of the slot of the rear bracket. The shear member may be configured to shear at a predetermined shear force to permit travel of the second end to a rear portion of the slot. The shear member may be a bolt or a pin.

The structural member may further include an elbow bracket that connects the outer end of the arm to the first end. The elbow bracket may have a weld tab welded to a front side of the arm. The elbow bracket may be fastened to the first end of the elongate member and the outer end of the arm.

A lateral beam may be joined to an inner sidewall of the rail and form a portion of the frame. The rear bracket may be aligned with a lateral beam of the frame. For example, the lateral beam may be joined to a side of the rail that is opposite the rear bracket such that the rear bracket and the lateral beam have an overlapping longitudinal position on the rail.

The vehicle may further include a bumper connected to the frame and defining a rear cavity. The structural member may be located behind the bumper. For example, the first end of the curved elongate member may be disposed in the cavity of the bumper.

According to another embodiment, a vehicle includes a longitudinal frame rail and a structural member. The structural member includes a front bracket joined to the rail and having an arm extending outwardly therefrom. The structural member further includes an elongate member having a forward end connected to an outer end of the arm and extending rearwardly therefrom to a rear end that is spaced from the rail. The structural member further includes a rear abutment fixed relative to the rail at a location behind the rear end to define a gap therebetween. The gap defines a travel allowing the elongate member to move from a forward resting position to a rearward position in which the rear end is disposed against the rear abutment.

The rear abutment may be formed on a bracket connected to the rail. The bracket may be a restrictor bracket that is disposed rearwardly of the rear end with a gap defined therebetween. Alternatively, the bracket may define a slot that receives the rear end of the elongate member therein. A width of the slot may be wider than a width of the second end to form the gap. Here, the rear abutment is formed on a rear peripheral wall of the slot.

The elongate member may be tube, or an assembly of stampings welded together. The elongate member may define a body-mount receiving area configured to receive a body mount for connecting the frame to a body of the vehicle. A reinforcement plate may be connected to the rear end of the elongate member. A second gap is defined between the plate and the rail.

The structural member may further include an elbow bracket connected between the arm and the front end. Fasteners, welding, or both may be used to create a robust joint at the elbow bracket.

A shear member may be used to secure the rear end of the elongate member. For example, a shear member may be arranged to be intact when the rear end is in the forward resting position and to be sheared when the second end is in the rearward position. The shear member may be a bolt, pin, rivet, weld, or adhesive.

According to yet another embodiment, a vehicle structural assembly includes a longitudinal frame rail, an arm fixed relative to the frame rail and extending outwardly therefrom, a bracket connected to the frame rail rearwardly of the arm, and an elongate member extending from the arm to the bracket. The vehicle structural assembly further includes a shear member having a cylindrical body extending through the bracket and the elongate member to join the elongate member to the bracket when intact. The shear member is designed shear responsive to a threshold force acting on the elongate body to allow rearward movement of the arm and elongate member. The bracket may define a slot that receives a rear end of the elongate body therein. The slot may be wider than a width of the rear end to permit the rearward movement within the slot.

### BRIEF DESCRIPTION OF THE DRAWINGS

FIG. 1 is a bottom view of a front end of a vehicle having a structural member attached to a frame rail of the vehicle.

FIG. 2 is a side perspective view of the structural member attached to a frame rail of the vehicle.

FIG. 3 is front perspective view of the structural member attached to a frame rail of the vehicle.

FIG. 4 is a side perspective view of the structural member attached to a frame rail of the vehicle.

FIG. 5 is a front perspective view of another structural member attached to a frame rail of the vehicle.

FIG. 6 is a top view of the structural member of FIG. 5 attached to a frame rail of the vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein, such as front, back, end, side, etc., are made with reference to the views and orientations shown in the exemplary figures. Terms such as “outer” and “inner” are relative to the vehicle. For example, an “outer” surface means that the surface faces away from the vehicle, whereas an “inner” surface means the surface faces towards the vehicle. The terms, connected, attached, etc., refer to directly or indirectly connected, attached, etc., unless otherwise indicated explicitly or by context.

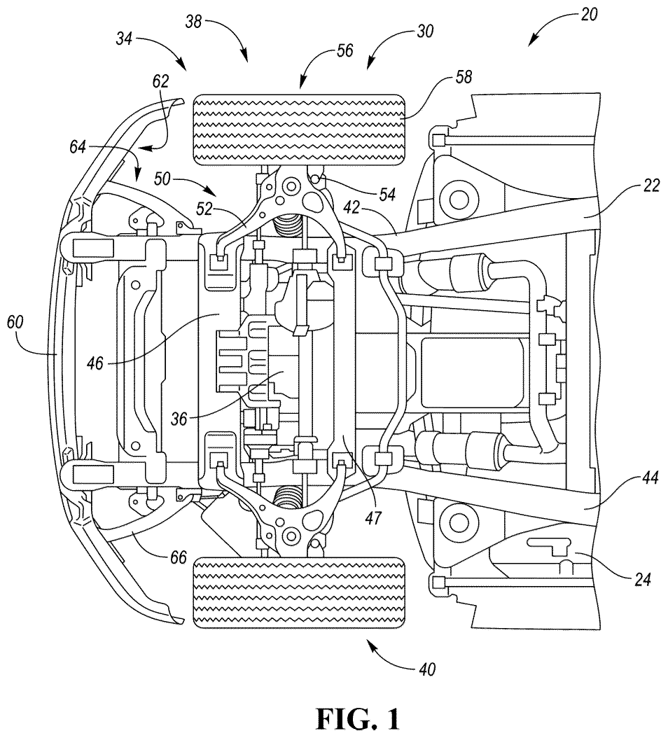

Referring to FIG. 1, a vehicle 20, such as a pickup truck, includes a frame 22 for supporting a body 24, vehicle suspension, and other loads. The example vehicle 20 is shown as including an engine 36, however, the vehicle 20 may be an electric vehicle in other embodiments. The frame 22 may include opposing longitudinal side rails 42, 44 that may extend the length of the vehicle. The side rails 42, 44 are interconnected by lateral beams. For example, front lateral beams 46, 47 extend between the side rails 42, 44 at the front portion 34 of the vehicle. The beams 46, 47 may form an engine cradle that supports the engine 36 (if provided). The vehicle 20 may include a plurality of body mounts. Each of the body mounts may be attached to a portion of the frame, such as the side rails 42, 44.

A front axle 30 is attached to the frame 22 near a front portion 34 of the vehicle 20 and a rear axle (not shown) is attached to the frame near a rear portion of the vehicle 20. The front axle 30 includes wheel assemblies 38, 40 at the front portion 34 of the vehicle 20. The rear axle of the vehicle 20 also includes wheel assemblies (not shown). The front and rear axles are supported to the vehicle by a suspension system 50. At each front wheel assembly, the suspension system 50 may include a lower control arm 52 pivotally connected to the side rail 42 (or lateral beams 46, 47) on one side and pivotally connected to a knuckle 54 of the wheel assembly 38 at the other side. The knuckle 54 supports the wheel 56 and tire 58 of the wheel assembly 38.

A bumper 60 is provided at the front of the vehicle 20 and extends between the frame rails 42, 44. The bumper 60 may be directly connected to the frame rails 42, 44 or connected via one or more intermediary components. The bumper 60 may be a three-sided beam having an open backside that defines a cavity 62.

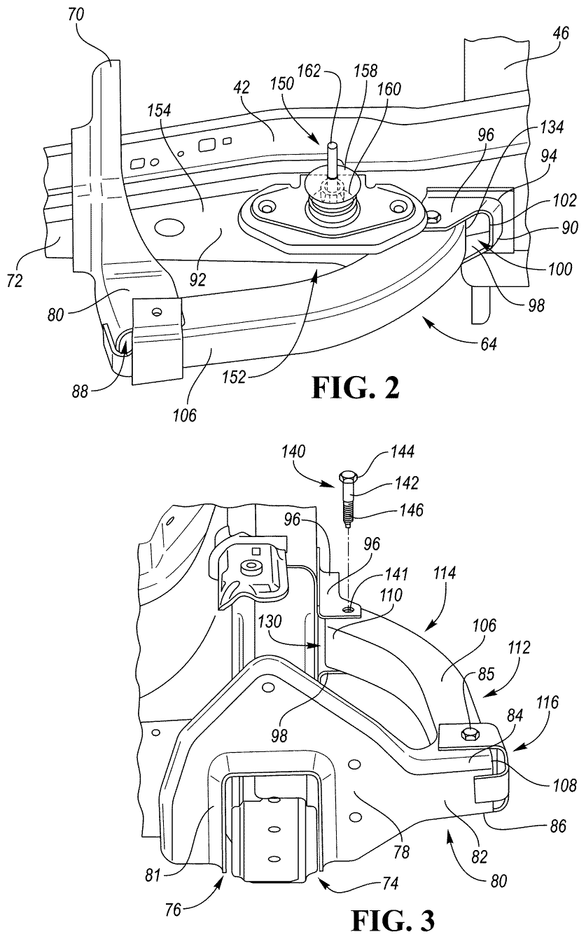

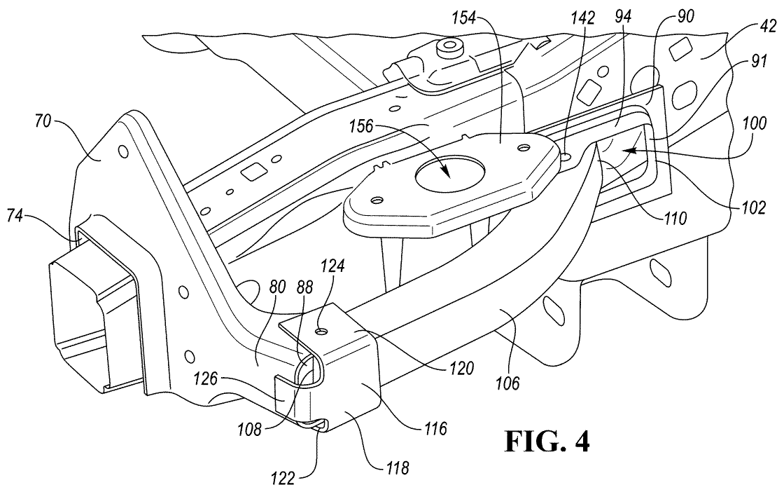

Referring to FIGS. 1-4, structural members 64, 66 are provided behind the bumper 60 and outside the frame rails 42, 44. The structural members 64, 66 are disposed forward of the front axle 30 and the wheel assemblies 38, 40. In the illustrated embodiment, the structural members 64, 66 are partially received within the cavity 62 of the bumper 60 but are not connected to the bumper. In other embodiments, the structural member 64, 66 may be connected to the bumper 60.

The structural member 64 may include a front bracket 70 joined to the rail 40. The front bracket 70 is located behind the bumper 60 and may be partially received within the cavity 62 or may be fully spaced from the bumper. The front bracket 70 may be directly connected to the rail 40 by welding or other joining techniques. The front bracket 70 may define an opening 74, e.g., an open slot extending from the bottom, so that the front bracket 70 may be received on the rail 40. The front bracket 70 may generally include a front face 78 that includes a flange portion 81 forming the periphery of the opening 74. The front face 78 is oriented orthogonal to the longitudinal direction of the vehicle to face the backside of the bumper 60. The front bracket 70 has an arm 80 extending outwardly from the front face 78 to project from the rail 42. The arm 80 includes a front side 82, a top flange 84, and a bottom flange 86. The top and bottom flanges 84, 86 are spaced apart to define a receiving area 88.

The structural member 64 may further include a rear bracket 90 connected to the rail 42 at a location longitudinally spaced from the front bracket 70. Unlike the front bracket 70 that is received on the rail 42 via an opening 74, the rear bracket 90 is smaller and connected on the sidewall 92 of the rail 40 in the example embodiment. The rear bracket 90 may be located on the rail 42 near the lateral beam 46 so that forces on the bracket 90 may be transferred to the beam 46. That is, the lateral beam 46 may be joined to a side of the rail 42 that is opposite the rear bracket 90 such that the rear bracket and the lateral beam have an overlapping longitudinal position on the rail. In the illustrated example, the bracket 90 is slightly forward of the lateral beam 46 with only the back portion of the bracket 90 overlapping with the front portion of the beam 46. In other embodiments, the overlapping may be centered or with the front portion of the rear bracket 90 overlapping the rear portion of the beam 46.

The rear bracket 90 may include a flange 94 that is connected to the rail 42 via welding, fasteners, or the like. The rear bracket 90 may also include an upper planar member 96 and a lower planar member 98 that are spaced apart. A front side of the rear bracket 90 may be open. The rear bracket 90 may define a slot 100 that is elongated in the longitudinal direction of the vehicle. The slot 100 extends longitudinally from the front side of the rear bracket 90 to an abutment 91 located on the rear side 102 of the bracket 90. The slot 100 extends vertically between the upper and lower planar members 96, 98.

A curved elongate member 106 extends between the front bracket 70 and the rear bracket 90. The elongate member 106 extends rearwardly in the longitudinal direction of the vehicle but, due to the curve, the front end 108 of the elongate member 106 is farther outboard than the rear end 110. The elongate member 106 may be a hollow tube as shown in the illustrated example or may be a stamping assembly formed from discrete pieces welded together. In the illustrated embodiment, the elongate member 106 is a four-sided tube formed from high-strength steel alloy. The curved elongate member 106 may be a compound curve as opposed to a single radius and may include one or more straight segments. For example, a forward portion 112 of the elongate member 106 may be straighter than a rear portion 114.

The front end 108 of the elongate member 106 is received within the receiving area 88 of the arm 80. The receiving area 88 may be sized to approximate the size of the front end 108, albeit slightly larger to provide clearance for insertion. Alternatively, the receiving area 88 may be the same size or smaller than the front end 108 requiring force for insertion to create an interference fit. An elbow bracket 116 may support the connection between the front end 108 and the arm 80. The elbow bracket 116 may include an outer side 118, a top 120, and a bottom 122 that cooperate to define a cavity. The cavity is sized so that the elbow bracket 116 can be received over the arm 80 and the elongate member 106. The arm 80, elbow bracket 116, and elongate member 106 may be connected to each other by a fastener 85 extending through the shown hole 124 that extends vertically through the joint. The fastener 85 may be a bolt, a pin, a rivet, or the like. The elbow bracket 116 may also include a weld flange 126 that extends over a front side of the arm 80 and welded thereto. Additional welds may be provided between the elbow bracket 116, the elongate member 106, and/or the front bracket 70 in some embodiments. In others, the fastener 85 provides the connection at the joint.

In the illustrated embodiment, the rear end 110 is not attached to the frame rail 42 but rather is spaced therefrom to define a gap 130. The rear bracket 90 supports the rear end 110 of the elongate member 106 by receiving the rear end 110 within the slot 100. The height of the slot 100 may approximate the height of the rear end 110, whereas the width of the slot 100 is wider than the width of the rear end 110 to allow travel of the elongate member 106 within the slot 100. The travel allows the elongate member 106 to move rearwardly from the resting position (illustrated) to a rearward position (not shown) in which the backside 134 of the second end 110 is disposed against the rear abutment 91 of the rear bracket 90.

A shear member 140 connects the rear end 110 to the rear bracket 90 by extending vertically through the upper and lower members 96, 98 and the rear end 110. The rear bracket 90 and the rear end 110 may define holes 141 for the shear member 140. The shear member 140 may have a cylindrical body 142 (sometimes called a shank) that extends from a head 144. In one embodiment, the shear member 140 is a bolt having threads 146 defined in at least the lower portion of the cylindrical body 142. The threads 146 are configured to screw into a nut or tapped hole. In other embodiments, the shear member 140 is a pin or rivet in which case threads are not provided. It is to be understood that these are just examples and the shear member 140 may be any component designed to shear and release the connection between the elongate member 106 and the rear bracket 90. Alternatives include a weak weld, adhesive, and the like.

The shear member 140 is designed to have a predetermined shear force such that the shear member 140 shears when that force is exceeded. The shear force may be developed by an external force acting on the front bracket 70 or the elongate member 106. The shear member 140 forms the connection between the elongate member 106 and the rear bracket 90 when the elongate member is in the resting position. When the force acting on the elongate member 106 exceeds the predefined shear force, the shear member 140 shears releasing the connection between the elongate member 106 and the rear bracket 90. The released rearend 110 may now travel rearwardly in the slot 100 until reaching the rear abutment 91, which is the end of its travel.

One of the body mounts 150 may be located within an area 152 defined between the rail 42 and the structural member 64. That is, the body mount 150 is located rearward of the front bracket 70 and forward of the rear bracket 90. The body mount 150 may be welded to the outer side of the frame rail 42. The body mount 150 may include an upper planar surface 154 that defines a central opening 156. A body mount bushing assembly 158 is received within the hole 156. The assembly 158 may include a bushing 160 seated against the periphery of the opening 156 and a fastener 162 extending upwardly through a center of the bushing 160. The fastener connects with its counterpart on the vehicle body to secure the body to the frame.

The structural member 66 may be the same as the structural member 64 and for brevity will not be explained again.

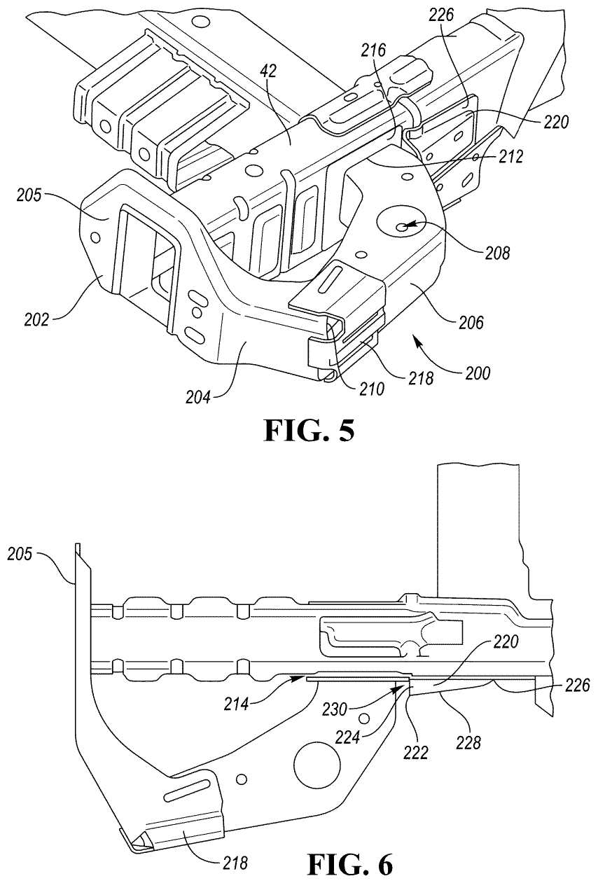

FIGS. 5 and 6 illustrate a structural member 200 according to another embodiment. Many aspects of the structural member 200 are similar to the above-described structural members 64, 66 and for brevity will not be discussed again. The structural member 200 may include a front bracket 202 attached to the frame rail 42 similar to the above-described front bracket. The front bracket 200 includes an arm 204 extending outwardly from the rail 42. The arm 204 may have a slight rearward angle relative to a front face 205 of the bracket. An elongate member 206 is connected to the outer end of the arm 204 and extends rearwardly therefrom. The elongate member 206 may be a plurality of stampings welded together to form a tubular structure with a hollow center. The elongate member 206 may define a body mount opening 208 configured to receive a body mount. The body mount may be similar to the above-described body mount. The elongate member 206 may be curved or formed from a plurality of sections that are angled relative to each other so that the front end 210 is more outboard than the rear end 212, which faces the side rail 42. Like the above-described embodiment, the rear end 212 is spaced from the side rail 42 to form a gap 214. A reinforcement plate 216 may be connected to the rearend 212.

An elbow bracket 218, which may be similar to the above-described elbow bracket, supports the joint between the arm 204 and the elongate member 206. The elbow bracket 218 may be welded to the arm 204 and/or the elongate member 206. While not shown, one or more fasteners may also be used as described above. Additionally, the arm 204 and the elongate member 206 may be directly welded together.

Like the above-described structural members 64, 66, the rear end 212 of the elongate member 206 is not connected to the beam. This allows the structural member 52 to move rearwardly in certain scenarios. To prevent excessive rearward movement, a restrictor bracket 220 is connected to the sidewall of the side rail 42. The restrictor bracket 220 includes a rear abutment 222 formed on a front side 224 of the bracket 220. The restrictor bracket 220 may include a flange 226 that is welded or otherwise secured to the rail 42. The main body of the restrictor bracket 220 may be wedge-shaped and taper from the front side 224 towards the backside 226. That is, the distance between the outer plate 228 and the rail 42 reduces in the rearward longitudinal direction of the vehicle. The restrictor bracket 220 is spaced rearwardly from the second end 212 of the elongate member 206 forming a gap 230. The gap 230 provides travel for the second end 212 of the elongate member 206. That is, the gap 30 provides unimpeded rearward travel of the elongate member 206 from the resting position (shown) to a rear-most position (not shown) when the elongate member 206 touches the rear abutment 222.

While not shown, an additional bracket may be provided at the rear end 212 to support the structural member 200 to the rail 42. For example, a bracket like the rear bracket 90 may be utilized. In another embodiment, the bracket may be less robust than the rear bracket 90 and may simply be used to create a shearable connection with the rail 42. For example, a projection may be welded to the side rail 42 and extend outwardly therefrom. The projection may then be connected to the elongate member 206 by a shearable connection such as a pin, fastener, weak weld, or adhesive. Alternatively, the projection may be designed to shear.

The vehicle may further include a second structural member that is the same or similar to structural member 200 on the other side of the vehicle connected to the frame rail 44.

The above-described embodiments provide structural members that project outboard from the frame rails in front of the front wheel assemblies. The structural members are designed to move rearwardly due their lack of a rear connection with the frame rails and their designed travels. This provides structural members that can move responsive to external forces acting thereon.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a frame including a longitudinal rail; and
a structural member including:
a front bracket joined to the rail and having an arm that extends outwardly away from the rail,
a curved elongate member having a first end connected to an outer end of the arm and extending rearwardly therefrom to a second end that is spaced from the rail, and
a rear bracket connected to the rail, the rear bracket defining a slot that receives the second end of the curved elongate member therein, wherein a width of the slot is wider than a width of the second end such that the second end is rearwardly slidable within the slot.

2. The vehicle of claim 1 further comprising a front wheel assembly, wherein the structural member is disposed forward of the front wheel assembly.

3. The vehicle of claim 1, wherein the front bracket defines an opening and is received on the rail via the opening.

4. The vehicle of claim 1, wherein the second end of the curved elongate member is connected to the rear bracket by a shear member that connects the second end at a front portion of the slot of the rear bracket, wherein the shear member is configured to shear at a predetermined shear force to permit travel of the second end to a rear portion of the slot.

5. The vehicle of claim 4, wherein the shear member is a bolt or a pin.

6. The vehicle of claim 1, wherein the structural member further includes an elbow bracket that connects the outer end of the arm to the first end.

7. The vehicle of claim 6, wherein the elbow bracket includes a weld tab welded to a front side of the arm, and wherein the elbow bracket is fastened to the first end of the elongate member and the outer end of the arm.

8. The vehicle of claim 1, wherein the curved elongate member is a tube.

9. The vehicle of claim 1 further comprising a body mount connected to the rail between the front and rear brackets.

10. The vehicle of claim 1, wherein the frame further includes a lateral beam joined to a side of the rail that is opposite the rear bracket such that the rear bracket and the lateral beam have an overlapping longitudinal position on the rail.

11. The vehicle of claim 1 further comprising a bumper connected to the frame and defining a rear cavity, wherein the first end of the curved elongate member is disposed in the cavity.

12. A vehicle comprising:
a longitudinal frame rail; and
a structural member including:
a front bracket joined to the rail and having an arm extending outwardly therefrom,
an elongate member having a forward end connected to an outer end of the arm and extending rearwardly therefrom to a rear end that is spaced from the rail, and
a rear abutment fixed relative to the rail at a location behind the rear end to define a gap therebetween, wherein the gap defines a travel allowing the elongate member to move from a forward resting position to a rearward position in which the rear end is disposed against the rear abutment.

13. The vehicle of claim 12, wherein the rear abutment is formed on a bracket connected to the rail.

14. The vehicle of claim 12, wherein the structural member further includes a rear bracket connected to the rail, the rear bracket defining a slot that receives the rear end of the elongate member therein, wherein a width of the slot is wider than a width of the second end to form the gap, and wherein the rear abutment is formed on a rear peripheral wall of the slot.

15. The vehicle of claim 12, wherein the elongate member defines a body-mount receiving area.

16. The vehicle of claim 12 further comprising a reinforcement plate connected to the rear end of the elongate member, wherein a second gap is defined between the plate and the rail.

17. The vehicle of claim 12, wherein the structural member further includes an elbow bracket connected between the arm and the front end.

18. The vehicle of claim 12 further comprising a shear member arranged to be intact when the rear end is in the forward resting position and to be sheared when the second end is in the rearward position.

19. A vehicle structural assembly comprising:
a longitudinal frame rail;
an arm fixed relative to the frame rail and extending outwardly therefrom;
a bracket connected to the frame rail rearwardly of the arm;
an elongate member extending from the arm to the bracket; and
a shear member having a cylindrical body extending through the bracket and the elongate member to join the elongate member to the bracket when intact, wherein the shear member is configured to shear responsive to a threshold force acting on the elongate body to allow rearward movement of the arm and elongate member.

20. The vehicle structural assembly of claim 19, wherein the bracket defines a slot that receives a rear end of the elongate body therein, wherein the slot is wider than a width of the rear end to permit the rearward movement within the slot.
